(19) United States
(12) Patent Application Publication
(10) Pub. No.: US 2018/0260800 A1
(43) Pub. Date: Sep. 13, 2018

(54) UNMANNED VEHICLE IN SHOPPING ENVIRONMENT

(71) Applicant: Walmart Apollo, LLC, Bentonville, AR (US)

(72) Inventors: Stephen Tyler Caution, Bentonville, AR (US); Douglas Jahe Ryner, Cave Springs, AR (US); Yurgis Mauro Bacallao, Centerton, AR (US)

(21) Appl. No.: 15/912,951

(22) Filed: Mar. 6, 2018

Related U.S. Application Data
(60) Provisional application No. 62/467,882, filed on Mar. 7, 2017.

(51) Int. Cl. G06Q 20/20; G06K 9/00; G06Q 30/06; B64C 39/02; H04W 4/35; G05D 1/00

(52) U.S. Cl. CPC G06Q 20/208; G06Q 20/204; G06K 9/00671; B64C 2201/127; B64C 39/024; H04W 4/35; G05D 1/0088; G06Q 30/0623

(57) ABSTRACT

A system and method for acquiring store comprise establishing an electronic communication between a mobile device and a unmanned vehicle; tracking in a store by the unmanned vehicle a customer having the mobile device; collecting data by the unmanned vehicle regarding items of interest by the customer; and processing and outputting to the mobile device a result from the collected data, the result used by the customer to determine whether to purchase the items of interest based on the collected data.

### RELATED APPLICATIONS

This application claims the benefit of U.S. Provisional Patent Application No. 62/467,882, filed Mar. 7, 2017 and entitled “Unmanned Vehicle in Shopping Environment,” the contents of which are incorporated herein in their entirety.

### TECHNICAL FIELD

The present inventive concepts relate generally to shopping environments and more particularly to devices, systems and methods for assisting customers and/or workers in those shopping environments.

### BACKGROUND

In a modern retail store environment, there is an ongoing desire to improve the customer experience and/or convenience for the customer, especially in view of the steady increase in other shopping options, such as online shopping. One area where a shopping experience may be improved is during a shopping trip, during which the customer continuously adds items for purchase to a shopping cart or basket and is required to unload the items from the shopping cart or basket onto a checkout counter at the end of the trip.

### SUMMARY

In one aspect, provided is a method for acquiring store items, comprising: establishing an electronic communication between a mobile device and a unmanned vehicle by pairing the unmanned vehicle and the mobile device; tracking in a store by the unmanned vehicle a customer having the mobile device and monitoring acts performed by the customer; collecting data by a sensing device of the unmanned vehicle regarding items of interest by the customer; processing and outputting to the mobile device a result from the collected data, the result used to determine a status of the items of interest, the status including a purchase or planned purchase of the items of interest; and outputting the result to a point of sale device for processing the items of interest according to the collected data.

In some embodiments, the unmanned vehicle is a unmanned aerial vehicle (UAV) or an autonomous ground vehicle (AGV).

In some embodiments, the unmanned vehicle includes a scanning device for collecting the data regarding the items of interest when the user places the items of interest in a shopping cart or basket.

In some embodiments, the unmanned vehicle includes a sensor for collecting the data regarding the items of interest.

In some embodiments, the unmanned vehicle includes a location determining device to track a current location of the mobile device and to add data on correct items to the system.

In some embodiments, the unmanned is part of a network of drones that form a smart grid in the store.

In some embodiments, the collected data includes data regarding customer activities performed during a shopping trip by the customer at the store.

In some embodiments, the method further comprises collecting by the unmanned vehicle the items of interest after the customer scans the items of interest with the mobile device; and delivering by the unmanned vehicle the items of interest to the checkout counter.

In another aspect, provided is a system for acquiring store items, comprising: an electronic interface that establishes an electronic communication between a mobile device and a unmanned vehicle; a location determining device at the unmanned vehicle that tracks a current location of the mobile device; a data storage device that collects data by the unmanned vehicle regarding items of interest by a customer using the mobile device; and a special purpose process that processes and outputs to the mobile device a result from the collected data, the result used by the customer to determine whether to purchase the items of interest based on the collected data.

In some embodiments, a scanning device collects the data regarding the items of interest when the user places the items of interest in a shopping cart or basket.

In some embodiments, a sensor for collecting the data regarding the items of interest.

In some embodiments, the location determining device adds data on correct items to the system.

In some embodiments, a smart grid processor arranges a network of unmanned vehicles that form a smart grid in the store.

In some embodiments, the system includes a scanning application, a pairing application 62, and a shopping application executed at the mobile device, at least one that exchanges data in the electronic communication with the unmanned vehicle.

In another aspect, provided is a method for acquiring store items, comprising: detecting by an unmanned vehicle a placement of an item into a shopping cart; generating a digital basket that includes data regarding the item in the shopping cart; and executing a point of sale operation that includes the digital basket data.

### BRIEF DESCRIPTION OF THE DRAWINGS

FIG. 1 is a diagram of a retail environment in which embodiments of the present inventive concepts can be practiced.

FIG. 2 comprises a network diagram of a shopping assistance system in a retail environment in accordance with various embodiments;

FIG. 3 is a flow diagram of a method for acquiring store items, in accordance with some embodiments.

FIG. 4 is a flow diagram of a method for using a drone paired with a mobile device to assist a store customer in shopping for store items, in accordance with some embodiments.

### DETAILED DESCRIPTION OF EMBODIMENTS

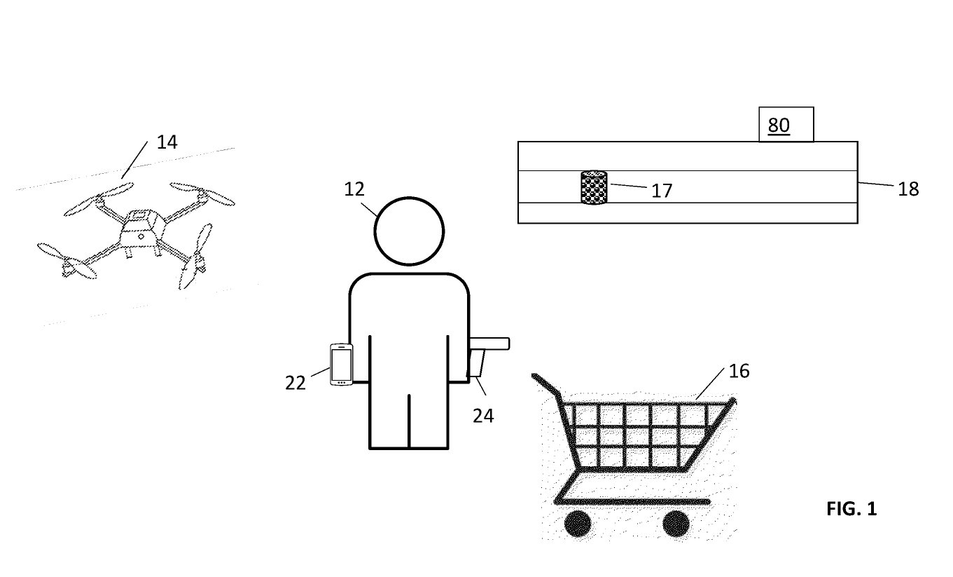

In various embodiments, systems, devices and methods are provided for assisting persons acquire items of interest in a retail environment, such as a store or other shopping facility providing products for display and/or purchase. For example, the retail environment in FIG. 1 may include one or more of sales floor areas, aisles lined with shelves, checkout locations, parking locations, entrance and exit areas, stock room areas, and so on. A retail environment may include a single store operated by one merchant or may be a collection of stores covering multiple merchants such as a mall.

In brief overview, embodiments include unmanned vehicles such as aerial drones that capture information about a store customer's shopping items and add this information digitally to a customer-identified mobile device.

Referring to the example of FIG. 1, a store customer 12 at a shopping facility may participate in a shopping experience, e.g., a supermarket, department store, or other retail establishment. A typical shopping experience may include the customer 12 selecting a shopping basket 16 or cart after entering the store, and using the basket 16 or cart to collect items as the customer 12 walks up and down the various aisles and/or regions of the store.

In some embodiments, an unmanned vehicle 14 follows the store customer 12 and collects data regarding the customer's acquisition of items, such as store item 17 from shelf 18. The unmanned vehicle 14 may rely on the pairing with the customer's mobile device 22 to track or otherwise follow the customer. In other embodiments, the unmanned vehicle 14 includes one or more of a camera and/or other intelligent vision sensors, geoposition (GPS), gyro accelerometer, compass, and so on to detect and follow the customer. When following the store customer 12, the unmanned vehicle 14 outputs information in electronic data format to a remote controller server, such as the store computer 20. The unmanned vehicle 14 may be a drone, autonomous ground vehicle (AGV), or other automated, robotic mobile devices, e.g., motorized transport units, that are capable of self-powered movement through a space of the shopping facility and assisting the customer 12 with shopping-related functions. Although a primary function of the unmanned vehicle 14 is to monitor customer activities, for example, removing items from a shelf and placing them in a cart 16 or basket, the unmanned vehicle 14 may perform other predictable tasks such as removing the item 17 from the shelf 18 using a robotic arm on behalf of the customer, for example, in response to a request sent electronically from the mobile device 22 to the unmanned vehicle 14. Thus, the unmanned vehicle 14 may include a dispenser, collector, or a combination thereof for transporting the item 17.

The unmanned vehicle 14 includes an electronic interface that permits the unmanned vehicle 14 to be paired with a mobile device 22 possessed by the customer 12, and via the electronic communication formed by the pairing can exchange data with the mobile device 22, such as data collected regarding catalogued items taken by the customer 12. A pairing may be formed by a quick-response (QR) code scan, a selection made on an application executed at the mobile device 14, e.g., smartphone or the like, to the unmanned vehicle 14. The mobile device 22 is a store customer's personal computing device, such as a smartphone, electronic notebook or tablet, and so on.

A scanning device 24, for example, a store-provided electronic scanner configured to perform a scanning function, may be used to collect data regarding the items 17 of interest, for example, by scanning a barcode, QR code, or the like on the item 17 prior to or after placing the item 17 in the shopping cart 16. In some embodiments, the personal mobile device 22 such as a smartphone, electronic tablet, or the like can perform a scanning function. Item data may include description, pricing, inventory, expiration dates, and/or other information well-known for being retrieved from a barcode, QR code, or the like. Another feature of the scanning device 24 can permit the customer 12 to scan items of interest which can be automatically and electronically added to a queue for subsequent purchase at the end of a shopping trip.

The pairing between the mobile device 22 and the unmanned vehicle 14, e.g., via direct electronic communication, WiFi, and so on, permits the unmanned vehicle 14 to also receive and process scan results from the mobile device 22 and/or scanning device 24. Before, during, or after an item 17 is scanned, the unmanned vehicle 14 can collect additional data such as taking pictures, videos, location information. This may be achieved by a camera or related sensor that captures images to collect data, which is used to count stock items or other inventory-related data. This data, for example, digital images, collected data, and so on may be processed by a point of sale system or other retail process. Captured additional data about the item scanned may be processed so that the items can be identified and sold to the customer even if the customer does not scan the item at a checkout counter or other scanning location.

In some embodiments, the communication between the mobile device 22 and the unmanned vehicle 14 may be passive. For example, a passive pairing occurs when the mobile device 22 is used for communicating with the unmanned vehicle 14, which performs a scanning operation on behalf of the mobile device 22 or scanner.

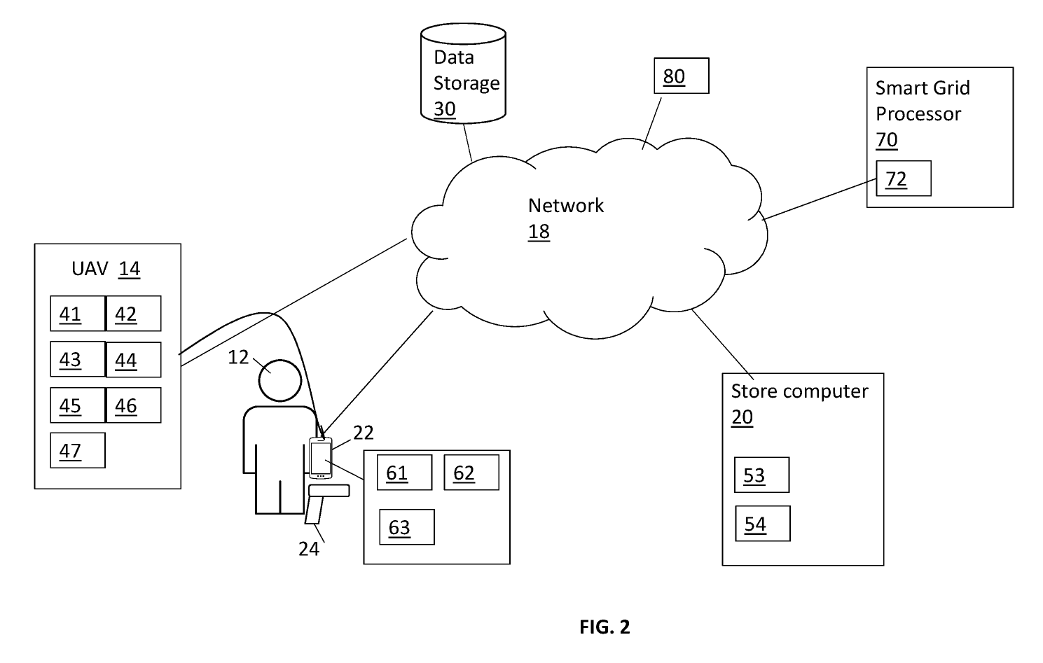

FIG. 2 comprises a network diagram of a shopping assistance system in a retail environment in accordance with various embodiments. The shopping assistance system may include some or all of the unmanned vehicle 14, the mobile device 22 and/or scanning device 24 of FIG. 1. In addition, the shopping assistance system in the retail environment may include some or all of a store computer 20, a data storage device 30, and a smart grid processor 70. The unmanned vehicle 14, the mobile device 22, scanning device 24, store computer 20, data storage device 30, and smart grid processor 70 may communicate with each other via an electronic communications network 16. The network 16 may be a local area network (LAN), a wide area network (WAN), wireless network, and/or any other electronic communication exchange environment. In some embodiments, the network 16 includes elements of a public or private data network such as the Internet. In some embodiments, the network 16 includes a cloud computing system comprising hardware computers, network connectors, and/or other components well-known for processing and storing cloud computing data. Some or all of the unmanned vehicle 14, the mobile device 22, scanning device 24, store computer 20, data storage device 30, and smart grid processor 70 may communicate directly with each other, for example, via a Bluetooth™ exchange or the like, without the need of the network 16.

As previously described, the unmanned vehicle 14 may be a drone, autonomous ground vehicle (AGV), or other automated, robotic mobile devices, e.g., motorized transport units, that are capable of self-powered movement through a space of the shopping facility and assisting the customer 12 with shopping-related functions. Accordingly, the unmanned vehicle 14 includes well-known components such as a motor, drive train, power source such as battery, and so on. An air-based unmanned vehicle such as an unmanned aerial vehicle (UAV) or drone may in addition include a rotor, wings, and so on, so that the UAV may move at a height about ground level. In other embodiments, the unmanned vehicle 14 may operate on wiring, pulleys, or related hardware arranged throughout the retail environment. In addition, the unmanned vehicle 14 may include a scanner 41, location determining device 42, data storage device 43, sensor communication device 44, pairing interface 45, and docking interface 46, and a task processor 47.

The scanner 41 may include a radio frequency identification (RFID) or optical based scanning device, camera, video recorder, or other image collection device to capture images of store items 17, sense and read optical patterns or the like, such as bar codes, QR codes, or the like that includes data regarding the items of interest 17. In some embodiments, the scanner 41 includes a three-dimensional scanner. In some embodiments, the scanner 41 performs object recognition and/or visual recognition of a captured image, in particular, of an item 17 of interest or a region around an item of interest. In some embodiments, the scanner 41 performs character recognition of an image. In some embodiments, the unmanned vehicle scanner 41 performs same or similar functions as the scanning device 24 used by the customer 12. The scanner 41 can be configured to collect images during specific times, such as when the customer 12 removes the item 17 from the shelf, when the item 17 is in the shopping cart 16, and so on. A data record may be automatically created that includes the collected image, a time when the image was collected, a metadata regarding the image, and so on, and stored at the data storage 30 for subsequent retrieval by a computer processor, for example, for analytics or other purpose. Captured additional information may include data regarding a situation where the customer interacts with an item, for example, temporarily removes an item of interest from a shelf but decides not to purchase the item and places the item back on the shelf. This is an example of customer buying behavior which can be determined by the sensors on the unmanned vehicle 14 and/or IOTs 80.

In some embodiments, the scanner 41 may comprise a distance measurement unit configured to detect a distance between the unmanned vehicle 14 and one or more objects or surfaces around the unmanned vehicle 14. The scanner 41 may include a sensor that determines a distance to objects in proximity to the sensor. In some embodiments, the sensor communication device 44 is part of the scanner 41. In some embodiments, a sensor comprises an optical based scanning device to sense and read optical patterns in proximity to the sensor, such as bar codes, and to determine proximity to nearby objects, avoid collisions, orient the unmanned vehicle 14 at a proper alignment orientation to engage a movable item. In some embodiments, the scanner includes facial recognition technology. In some embodiments, the scanner 41 includes a motion sensing input device to detect a movement of the customer 12 so that the unmanned vehicle 14 can follow the customer 12. In some embodiments, the scanner 41 may automatically output scanning results to the store computer 20 for processing, such a barcode label data or the like.

The location determining device 42 tracks a current location. The location determining device 42 may be constructed and arranged to communicate location data with the mobile device 22 using global position systems (GPS), beacons, UWB, WiFi hotspots, smart LED lights, or other triangulation methods. Other data used to detect a location may include particular activities detected by a sensor, IOT, or the like, and/or scheduled tasks, manager designated, customer requested, and so on.

The sensor communication device 44 may process data regarding the items 17 of interest collected by the vehicle scanner 41, the customer's scanner 24, the mobile device 22, and/or other sensing devices. The store environment may include a plurality of IoT devices 80, for example, an IoT device 80 at a store shelf, a floor aisle, or other relevant store locations. An IoT device 80 may provide sensor-based computing, for example, including a water meter, event detector, pressure sensor, temperature sensor, video camera, etc, which permits the system to connect physical things or objects together into an Internet of Things (IoT). Other IOT devices 80 may include but not be limited to a weight sensor, LIDAR, lid sonic sensor, and so on. Physical objects may be managed and controlled in real-time or near real-time. In some instances, a combination of IoT devices 80 and non-IoT sensors may collect data regarding a task.

The pairing interface 45 includes a network interface, such as a Bluetooth™ connector or the like for communicating with the customer's mobile device 22. A pairing generates a unique identification for the customer with respect to a particular shopping trip. Over the course of the shopping trip, there could be a number of different sensors following the customer. A controller at the store computer 20 may manage all of the logic to map sensors/scanners to customer based on proximity, workload, or battery charges.

The docking interface 46 is for recharging a rechargeable power source, such as a battery or the like. The docking interface 46 is aligned to a receptacle on a charging source and couples with the charging receptacle when in proximity with the charging receptacle. One of the docking interface 46 and the charging receptacle has a male connector and the other has a female connector for coupling during a power charging operation. The unmanned vehicle 14, after a checkout procedure including item purchases is performed, may un-pair the customer's mobile device 22 and automatically couple to the charging station for recharging. In some embodiments, the mobile device 22 is charged by the unmanned vehicle 14. For example, the unmanned vehicle 14 may include an apparatus for wirelessly charging the mobile device 22.

The task processor 47 processes a request for a task to be performed by the unmanned vehicle 14. For example, the customer 12 may enter a new item of interest to a shopping list stored at the mobile device 22. Via the pairing, the unmanned vehicle 14 may also add the new item of interest to its data storage device 43. The task processor 47 may establish a location of the item, and provide instructions to search for and locate the item of interest. When the customer 12 is within a proximity of the new item of interest, the unmanned vehicle 14 may automatically activate the sensor communication device 44 and/or scanner 41 to collect data regarding the new item of interest to establish if/when the new item is moved by the customer 12 to the shopping cart 16, or for the unmanned vehicle 14 to retrieve the item via robotic arms or the like on behalf of the customer 12.

The customer's mobile device 22 may include but not be limited to a scanning application 61, a pairing application 62, and a shopping application 63, which are stored at a memory device and executed by a processor of the mobile device 22.

The scanning application 61 can perform a scanning operation in lieu of a standalone scanner 24, or in addition to the scanner 24. In some examples, the scanner 24 may perform a scanning function in response to commands provided by the scanning application 61 executed at the mobile device 22.

The pairing application 62 communicates with the pairing interface 45 of the unmanned vehicle 14. The pairing application 62 permits commands, data, and the like to be output to the unmanned vehicle 14. For example, shopping list data of the shopping application 63 may be output via the pairing to the unmanned vehicle 14 which can be processed to determine information about the item and to output a result to the mobile device 14 from the unmanned vehicle 14.

The shopping application 63 permits the customer 12 to use the mobile device 22 to shop at the store, or more specifically, to perform a commercial function related to a purchase at the store. For example, shopping application 63 may process point-of-sale transactions. The shopping application 63 may include lists of items of interest for purchase, and status information, for example, whether the item 17 was retrieved from the shelf 18 and placed in the cart. In this example, the unmanned vehicle 14 may capture a digital image of the item 17 or use its sensor 44 in communication with an IOT device 80 to determine that the item 17 was placed in the shopping cart 16, and send information along these lines to the mobile device via the pairing interface 45, which in turn updates a record in the shopping application 63. Alternatively, or in addition, this information may be stored at a cloud computer or other remote location such as the data storage device 30 and/or store computer 20.

The store computer 50 may include but not be limited to a digital basket 53 and a point of sale (POS) system 54. The POS system 54 may perform known point of sale functions such as payment processing, item barcode scanning, and so on. In some embodiments, the digital basket 53 is located on the mobile device 22, the data storage device 30, or other data repository. In some embodiments, the digital basket 53 is generated by data collected from the unmanned vehicle 14.

The digital basket 53 is formed by data collected by a combination of the unmanned vehicle 14 and the mobile device 22 that includes data records or logs of customer activities, item acquisition, e.g., identification of items placed in the shopping cart 16, and so on.

The smart grid processor 70 includes a central computer 72 that is configured to control a movement of the unmanned vehicle 14 throughout the store based on a variety of inputs. The smart grid processor 70 can provide data to the unmanned vehicle 14 so that the unmanned vehicle 14 follows the customer 12 throughout parts of the store within predetermined regions of an invisible boundary of a generated grid, geofence, or the like, and can be prevented from following the customer 12 to other regions of the store, such as a bathroom. The smart grid processor 70 may produce a plurality of grids, each associated with a different unmanned vehicle 14. In some embodiments, the smart grid processor 70 is capable of integrating an electronic map of the retail environment with physical locations of objects and store personnel and resources. Here, grids are applied which sections off the maps into access ways and blocked sections. One or more unmanned vehicles 14 use these grids for navigation and recognition.

The smart grid processor 70 may also permit a customer 12 to request assistance that includes the need for an unmanned vehicle 14, for example, to find an item. As previously described, the unmanned vehicle 14 can track a store customer, for example, using facial recognition features of the sensor, via pairing with the customer's mobile device 22, using a camera on the unmanned vehicle 14, and so on. In other embodiments, the unmanned vehicle 14 is configured to direct the customer 12 to an item of interest, for example, according to shopping list data 63 received by the unmanned vehicle 14, which identifies the item of interest and determines the item's location at a store by retrieving location data about the item from the store computer 20 or by the item data stored locally at the data storage device of the unmanned vehicle 14. The smart grid processor 70 can check to see if there is an available unmanned vehicle 14. Once assigned to a given user, and paired with the customer's mobile device 22, other users will not be able to control the already assigned unmanned vehicles 14.

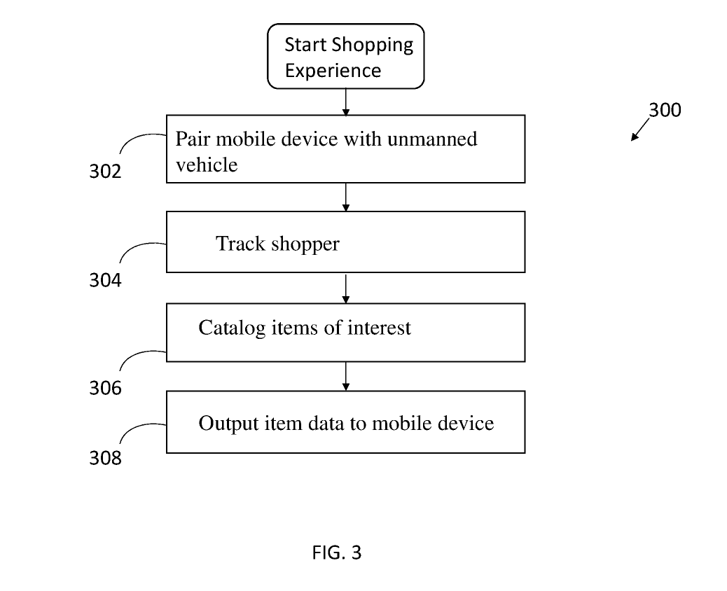

FIG. 3 is a flow diagram of a method 300 for acquiring store items, in accordance with some embodiments. The method 300 can be performed by one or more of the elements of the shopping assistance system of FIGS. 1 and 2.

At block 302, an electronic communication pairing is formed between the mobile device 22 and the unmanned vehicle 14 to exchange data therebetween. The pairing may be formed by a handshaking protocol executed between the mobile device 22 and the unmanned vehicle 14.

At block 304, the unmanned vehicle 14 tracks the shopper 12 throughout the store during the shopping trip, for example, via pairing connection, facial recognition, location tracking, or a combination thereof.

At block 306, the unmanned vehicle 14 catalogs items of interest 17, for example, using its scanner 41 and/or sensor communication device 44 to establish that the items 17 have been placed in the shopping cart 16, and at block 308 outputs data about the items to the mobile device 22. Catalogued data regarding the items may represent the list of items acquired by the customer at the store, or identified lists on the shopping list stored at the mobile device. Here, the unmanned vehicle 14 tracks items 17 in the customer's possession, for example, removed from the shelf 18 and added to the customer's cart 18, hands, basket, and so on. This collected data is output to the paired mobile device 22 for processing. For example, the unmanned vehicle 14 may scan an item 17 on the shelf 18, which includes a barcode on the item 17, or collects an image of a food nutrient label on the item 17. This data can be sent to the mobile device 22 for further processing. The mobile device 22 can process this data using its pairing application 62, and output the data to the digital basket 53. When the customer 12 completes the shopping trip, for example, acquires all of the items for interest and is ready to proceed with to a checkout, a payment may be initiated, for example, using a point of sale application on the mobile device 22. After the payment is made, and the checkout process is completed, the unmanned vehicle 14 may be electronically detached, or unpaired, from the mobile device 22, and may automatically return to a docking station or the like for recharging its power source.

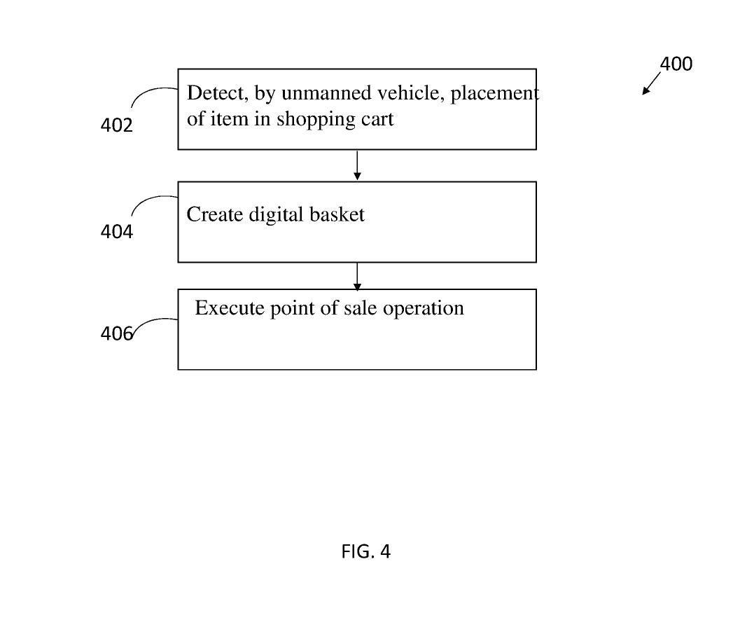

FIG. 4 is a flow diagram of a method 400 for using an unmanned vehicle 14 paired with a mobile device 22 to assist a store customer in shopping for store items 17, in accordance with some embodiments. The method 300 can be performed by one or more of the elements of the shopping assistance system of FIGS. 1 and 2.

At block 402, the unmanned vehicle 14 detects placement of an item 17 in a shopping cart.

At block 404, a digital basket is created, for example, when a pairing is complete. Contents of the digital basket are updated as the customer is tracked throughout the store. In some embodiments, the digital basket is created by the unmanned vehicle 14, and more specifically, in response to data collected by the unmanned vehicle 14. In other embodiments, the digital basket is generated by, and/or otherwise stored on, the mobile device 22, and populated with data related items for purchase, items retrieved and placed in the shopping cart, and so on.

At block 406, a point of sale operation is executed.

As described herein, some or all of the systems and methods in accordance with some embodiments are implemented in a computer system. The computer system may generally comprise a processor, an input device coupled to the processor, an output device coupled to the processor, and memory devices coupled to the processor via a bus or other signal-carrying connector. The processor may perform computations and control the functions of a computer, including executing instructions included in computer code for the tools and programs capable of implementing a method in the manner prescribed by the embodiments of the figures using the system described with respect to the figures, wherein the instructions of the computer code may be executed by processor via memory device. The computer code may include software or program instructions that may implement one or more algorithms for implementing the systems and methods, as described in detail above. The processor may execute the computer code.

A memory device may include input data. The input data includes any inputs required by the computer code. The output device may display output from the computer code. The memory device may be used as a computer usable storage medium (or program storage device) having a computer readable program embodied therein and/or having other data stored therein, wherein the computer readable program comprises the computer code. Generally, a computer program product (or, alternatively, an article of manufacture) of the computer system may comprise said computer usable storage medium (or said program storage device).

Memory devices include any known computer readable storage medium, including those described in detail below. In one embodiment, cache memory elements of memory devices may provide temporary storage of at least some program code in order to reduce the number of times code must be retrieved from bulk storage while instructions of the computer code are executed. Moreover, similar to processor, memory device may reside at a single physical location, including one or more types of data storage, or be distributed across a plurality of physical systems in various forms. Further, memory device can include data distributed across, for example, a local area network (LAN) or a wide area network (WAN). Further, memory device may include an operating system (not shown) and may include other systems not shown.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to embodiments of the present inventive concepts. Thus, an embodiment of the present invention discloses a process for supporting computer infrastructure, where the process includes providing at least one support service for at least one of integrating, hosting, maintaining and deploying computer-readable code in a computer system including one or more processor(s), wherein the processor(s) carry out instructions contained in the computer code causing the computer system to allow an employment and operation of embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method according to embodiments herein. Thus, the present invention discloses a process for supporting, deploying and/or integrating computer infrastructure, integrating, hosting, maintaining, and deploying computer-readable code into the computer system, wherein the code in combination with the computer system is capable of performing a method according to some embodiments.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for acquiring store items, comprising:
establishing an electronic communication between a mobile device and a unmanned vehicle by pairing the unmanned vehicle and the mobile device;
tracking in a store by the unmanned vehicle a customer having the mobile device and monitoring acts performed by the customer;
collecting data by a sensing device of the unmanned vehicle regarding items of interest by the customer;
processing and outputting to the mobile device a result from the collected data, the result used to determine a status of the items of interest, the status including a purchase or planned purchase of the items of interest; and
outputting the result to a point of sale device for processing the items of interest according to the collected data.

2. The method of claim 1, wherein the unmanned vehicle is an unmanned aerial vehicle (UAV) or an autonomous ground vehicle (AGV).

3. The method of claim 1, wherein the unmanned vehicle includes a scanning device for collecting the data regarding the items of interest when the user places the items of interest in a shopping cart or basket.

4. The method of claim 1, wherein the unmanned vehicle includes a sensor for collecting the data regarding the items of interest.

5. The method of claim 1, wherein the unmanned vehicle includes a location determining device to track a current location of the mobile device and to add data on correct items to the system.

6. The method of claim 1, wherein the unmanned vehicle is part of a network of drones that form a smart grid in the store.

7. The method of claim 1, wherein the collected data includes data regarding customer activities performed during a shopping trip by the customer at the store.

8. The method of claim 1, further comprising:
collecting by the unmanned vehicle the items of interest after the customer scans the items of interest with the mobile device; and
delivering by the unmanned vehicle the items of interest to the checkout counter.

9. A system for acquiring store items, comprising:
an electronic interface that establishes an electronic communication between a mobile device and a unmanned vehicle;
a location determining device at the unmanned vehicle that tracks a current location of the mobile device;
a data storage device that collects data by the unmanned vehicle regarding items of interest by a customer using the mobile device; and
a special purpose processor that processes and outputs to the mobile device a result from the collected data, the result used by the customer to determine whether to purchase the items of interest based on the collected data.

10. The system of claim 9, further comprising a scanning device for collecting the data regarding the items of interest when the user places the items of interest in a shopping cart or basket.

11. The system of claim 9, further comprising a sensor for collecting the data regarding the items of interest.

12. The system of claim 9, wherein the location determining device adds correct items to the system.

13. The system of claim 9, further comprising a smart grid processor that arranges a network of unmanned vehicles that form a smart grid in the store.

14. The system of claim 9, further comprising a scanning application, a pairing application, and a shopping application executed at the mobile device, at least one that exchanges data in the electronic communication with the unmanned vehicle.

15. A method for acquiring store items, comprising:
detecting by an unmanned vehicle a placement of an item into a shopping cart;
generating a digital basket that includes data regarding the item in the shopping cart; and
executing a point of sale operation that includes the digital basket data.
